(19) United States
(12) Patent Application Publication
(10) Pub. No.: US 2019/0318365 A1
(43) Pub. Date: Oct. 17, 2019

(54) System for Generation of Carbon Credits Through Verifiable Energy Savings Resulting in Reduced Carbon Emissions

(71) Applicants: Donn K. Harms, Del Mar, CA (US); Sal Amarillas, San Diego, CA (US)

(72) Inventors: Donn K. Harms, Del Mar, CA (US); Sal Amarillas, San Diego, CA (US)

(21) Appl. No.: 16/302,808

(22) PCT Filed: May 18, 2017
(86) PCT No.: PCT/US2017/033405

§ 371 Date: Nov. 19, 2018

Related U.S. Application Data
(60) Provisional application No. 62/338,299, filed on May 18, 2016.

(51) Int. Cl. G06Q 30/00; G06Q 30/02; G06Q 50/06

(52) U.S. Cl. CPC G06Q 30/018; G06Q 50/01; G06Q 50/06; G06Q 30/0239

(57) ABSTRACT

A method for saving electric energy and generating saleable carbon credits based on an amount of electric energy saved using a plurality of electric energy saving components adapted for an operative positioning in-between an electricity supply and a user appliance consuming said electricity supply. Proceeds from the sale of carbon credits based on saved electricity is sold to generate revenue for subsequent purchase and distribution of the energy saving components to subsequent users to accelerate distribution and use of the energy saving components and to accelerate the decrease in carbon emissions.

This application claims the benefit of Provisional Patent Application No. 62/338,299 filed on May 18, 2016 and is incorporated herein in its entirety.

### BACKGROUND OF THE INVENTION

### 1. Field of the Invention

The present invention relates generally to an energy saving device and method. More particularly, it relates to a method for the employment of individual autonomous or networked circuit-insertable power saving devices, wherein electric energy saved by each device inserted within each electric circuit may be reliably estimated and/or ascertained over time from device reporting of energy use and savings over a network. The energy saved may be reliably estimated for autonomous power saving devices using the reporting from networked devices. The energy saved by each power saving device and that from the aggregate total of such devices, may be reliably employed as a verified source for generation of saleable carbon credits. Such may be reported to users or over social media as a means to encourage more widespread use of the devices by users prone to modern social media inducement, to increase annual energy savings through such increased use. Proceeds from the sale of carbon credits can be employed to purchase and distribute subsequent energy saving devices to significantly enlarge the energy saved, and may also be paid to users as a reward for their developed savings of energy.

### 2. Prior Art

In recent years, with the advent of warnings concerning the environment and global warming, numerous international conferences have been held resulting in treaties wherein sovereign nations have avowed a goal to reduce carbon emissions from industry and government. To that end, many governments have and will derive standards requiring business and individuals and industries to reduce their carbon emissions. The goal being the worldwide reduction of carbon emitted into the atmosphere, and a reduction or slowing of temperature rising caused by carbon dioxide levels of the atmosphere.

However, in many cases, certain industries or businesses find themselves unable to comply with ever more restrictive carbon emission standards which are required by governments. This may be caused by an inability to reduce such emissions or by delays in such ability caused by a lack of required equipment or technology to accomplish the task. For example, in many cases, companies trying to meet government requirements for lower carbon emissions, have moved forward in good faith to do so but have been prevented by a lack of available equipment to purchase or delayed deliveries of such equipment. In other cases, the technology and equipment may be in development but lagging in actual delivery, leaving the carbon-offending company with good intentions but a failure to comply with government requirements. In many cases, failure to comply can cause significant costs in penalties levied by the governing authority.

In recent years, for companies and industries unable to comply with more stringent standards, whether it be due to a lack of available technology or due to a lack of equipment providing the technology to reduce carbon emissions, have been able to avoid such financial penalties through the purchase of carbon credits. Such carbon credits are employable by offending companies as a deduction from the total carbon emissions of the company, thereby lowering their total carbon emissions during a particular term of time. However, with the compressing time frames for compliance by many industries in many countries, there is a continual shortage of such carbon credits available for use in such instances.

Carbon credits are generated by the use of technology or agriculture or other means in a manner where such carbon credit generation parallels with an increase in reduction of carbon from the atmosphere. For example, the planting of hundreds of acres of new trees, contractually required to remain uncut for a long term of years, produces large plants which absorb carbon dioxide from the atmosphere. This planting of previously nonexistent trees to specifically exist for a term, and absorb carbon dioxide, provides a means to reduce carbon in the atmosphere which did not previously exist. In order to encourage such carbon absorbing activity, the planter of such trees is allowed to sell all or a portion of the calculated carbon absorbed by the trees over the term of time, as a credit, which may be used by the buyer in need of a lower carbon footprint, to avoid noncompliance with a standard or requirement of law.

However, with more and more countries signing onto the need for mitigating global warming, and the trailing of many industries in such countries from technically being able to meet new standards, there is an ongoing need to develop new sources for carbon savings to provide for carbon credits. Such sources, however, need not necessarily be agricultural since such sources require large amounts of land and are always tenuous due to the potential for loss of the plants employed to generate carbon credits from climate, disease, or fire or the like.

While other means exist for the development of energy saving means or carbon absorbing means as a manner to reduce carbon output and generate carbon credits for a duration, currently, there is a lack of such where little or no ongoing monitoring is required to maintain the carbon savings. Further, there is a lack of carbon reduction generating devices and schemes which are both provable and verifiable in real time. Further, there is a lack of such carbon savings means, which once deployed, are ungradable to save even more carbon emissions as technology improves or for temporary time frames where such might be advantageous.

Still further, where carbon credit generating energy saving schemes are implemented, a good percentage are unverifiable. This is because they are implemented in remote locations in third world countries and when verification is attempted at a later date, the installation has been removed, or moved to a new location by the indigenous people to whom the stove or oven or power generation device was given.

Still further, the cost of energy saving devices is generally prohibitive in nature to allow the purchase and use of such devices by those with low or even middle incomes, and thus they are not purchase or employed and excess energy is used by the largest portion of the population.

The system herein provides a verifiable method and apparatus which, when implemented in thousands of locations, will save significant amounts of electric energy. Such will result in a significant reduction in carbon emissions and thereby provide system to generate carbon credits which may be employed to help industries unable to quickly meet new or more stringent standards. However, the system herein is configured using components capable of initial verification of energy savings over a defined time, which operate autonomously. Further, and even more preferable, the system herein is also employable in a fashion wherein the energy saving from carbon reducing devices, can be verified in real time, and which can provide information or be upgraded to increase the actual carbon savings over time with the same deployed devices.

Still further, the method herein, is employable to encourage users to save more energy through the implementation of social media updates to the social media page or site of each user, payment of proceeds from carbon credit sales to users, and, the purchase of energy saving devices for free or discounted distribution to new users who would not buy or used the devices due to the cost of such.

The forgoing examples of related art and limitations related therewith are intended to be illustrative and not exclusive, and they do not imply any limitations on the energy and carbon emission saving device and method described and claimed herein. Various limitations of the related art are already known or will become apparent to those skilled in the art upon a reading and understanding of the specification below and the accompanying drawings.

An object of the present invention is to provide a system employing autonomous energy savings components which yield a calculable amount of electrical energy savings providing a resulting carbon emission reductions.

It is another object of this invention to provide a system for energy savings and carbon emission reduction in a manner adapted to generate carbon credits to fund the system, which employs networked energy savings components capable of real time reporting of energy savings and resulting carbon reduction, which can show increases over that calculated were the components autonomous.

It is a further objection of this invention to employ such networked energy savings components adapted to generate carbon reduction and credits, which can be upgraded over a network to increase efficiency or change operation to temporarily or permanently increase energy savings.

It is yet an additional object of this invention, to employ energy savings devices which conserve electricity consumption, and which are configured or remotely configurable to increase or decrease such savings and to change operation during such energy savings should such operation interfere with communication over circuits carrying electricity.

It is a further object of this invention to employ and deploy such energy savings components to users, and provide information concerning energy savings on an ongoing basis to such users, as an inducement to encourage ongoing and increasing use.

Further, it is an object of this invention, to use proceeds from the sale of carbon credits generated by energy savings of installed devices, to purchase and distribute subsequent rounds of energy saving devices to new users who would otherwise not purchase them due to cost.

Finally, it is an object of this invention to use location information reported from the energy saving devices, to determine localized energy savings based on localized power generation techniques, and thereby generate carbon credits from such savings employable locally or remotely to offset pollution.

### SUMMARY OF THE INVENTION

The present invention provides a system employing user installed, or factory installed, electric energy saving components which significantly decrease the electric energy consumed by an electric motor such as in washing machines, fans, air conditioners and the like, or a resistive load such as lighting or a computer, in a manner adapted to both save energy, and generate carbon credits from such savings.

The system herein can employ either or both of an autonomous energy saving device which has a calculated energy saving for an assumed electric load over an assumed time, or more preferably installing such energy saving devices which are adapted to communicate over a network to provide real time data concerning energy savings to validate assumed energy savings, or allow for an upgrade to the calculated energy savings to thereby allow for the generation of additional carbon credits above those originally assumed by calculation. Profits from the sale of the carbon credits are employable for distributing more energy saving components to more users to thereby further increase electrical energy savings.

In a first step in the system, the energy saving devices are manufactured and distributed to users, in a configuration adapted for operative interface or insertion of the device, in-between an electricity consuming component such as a washer, refrigerator, air conditioner, motor, or other device, and their respective connection to a line providing electricity for operation. The device, for example, is configured on one side for electrical engagement with a wall socket of the local venue. On another side of the device it is configured for electrical engagement with the appliance or device requiring electric power from the socket.

Each device is operatively positioned in this installed position with the energy saving device interfaced between the electricity-using appliance, and the electric line providing electricity to the socket. Circuitry in the device is configured to operate and reduce the electric energy required by the attached appliance. This circuitry may include software and switching which is adapted or adaptable to the appliance, or electric consuming device engaged.

So positioned in the engaged position, the electric energy saving device will thereafter reduce the amount of electricity consumed by the engaged appliance, using such internal circuitry and if required, software to operate such circuitry. Such energy saving circuitry could for example be employed from that shown in U.S. Pat. Nos. 6,836,099, 6,690,594, 733,651, 5,821,726, 8,644,992, all of which are made part of this application by this reference thereto, and other patents related thereto by citation or by patent prosecution.

In a step required to calculate and verify that the energy saving device does in fact save electricity, and thereby reduces carbon emissions from generation of such electricity, the devices will be certified through testing with various electric consuming appliances, to achieve an aggregate amount of electricity each saves over a duration of time when operatively engaged. In this step, the devices are tested, and/or shown by demonstrable proof, that they are actually reducing the electricity used by an appliance with which it would be normally used by the attached electric appliance or device and that the methodologies employed for measuring the emission reductions the devices generate, provide a reduction in carbon emissions all of a portion of which may be employed for carbon credits.

For example, the system herein will employ third party standards such as the Verified Carbon Standard (VCS), Gold Standard, Climate Action Registry (CAR), American Carbon Registry and/or the Clean Development Mechanism (CDM), to verify the determined amount of electric energy saved and thereby the resulting carbon emission savings. Such carbon emission savings and electric energy savings relating thereto are in turn verified by independent third parties to validate and verify the calculated carbon emission savings and saleable carbon credits. Unlike present carbon savings schemes which turn out unverifiable, this step enables a business purchasing the carbon credits for their carbon offset programs to ensure the devices are producing carbon reduction and the carbon credits are valid.

In the system herein, the energy saving devices which are deployed to users, can either be autonomous, and operate independent of monitoring based on a calculated energy savings when operatively installed. Alternatively, the energy saving devices may include the ability of one-way or two-way network communication with each device over a network such as the internet, cellular towers, or over power lines themselves. In a mode of the system using autonomous devices, a total carbon emission savings over a determined duration of time will be determined according to the above standards and testing and verification. The carbon credits from the carbon emission savings for autonomous devices will therefor be fixed in an aggregate total amount over the time determined for operation of the autonomous device. These carbon credits are then sold and the proceeds either used to buy new devices which are distributed to users who cannot afford to buy them or would not due to income, or may also be shared with the users as an additional inducement by employing the carbon credit sale proceeds to partially pay their electric bill.

In the more preferred mode of the system herein, the energy saving devices will also be tested and certified to the above standards and validated for a calculated energy savings and carbon reduction. However, rather than being autonomous, and fixed in determined energy savings by such testing, validation, and calculation, these networked energy saving devices will each carry a device identifier and will be enabled to communicate electronically over a network such as the internet in a wired or wireless connection.

Using such network communication, each such energy saving device when installed and thus provided electric power, can communicate to a service provider herein, in real time, or at predetermined future times, their respective electric energy savings over a duration of time from a last reporting time from the device with the respective device identifier.

The deployment of networked energy savings devices, with individual identifiers, and one way or two way network communications capabilities is preferable in the system herein for a number of reasons. First, the tested and calculated savings and resulting carbon credits of the autonomous devices, must make concessions as to the energy saved based on averaging of the type of electric device to which they engage, and longevity, amongst other factors. In fact, the autonomous devices may save significantly more energy and carbon emissions than tested and validated for a particular device to which they engage. However, such must be averaged against those assumed to be engaged to other electric devices to validly predict energy savings and resulting carbon credits.

By employing the networked energy saving devices, with individual device identifiers, the system herein is provided with significant enhancement of reporting capability of each respective energy saving device connected to a network, as to the energy saved. Therefor should a networked device's actual energy savings, exceed the predetermined savings it is assigned as an autonomous device (should it not connect to a network), the system provider is provided with ongoing validation of actual energy savings and carbon reduction, which exceeds a predetermined minimum, and a resulting increase in saleable carbon credits, which are badly needed can provided for each such networked energy saving device.

In addition to the ongoing validation and reporting of actual energy savings from each networked energy saving device, the ability for each such device to communicate with the service provider computer or server, allows for the system provider to update the firmware or software operating the ongoing operation of the circuitry of the networked energy saving devices. Such will allow for improvements in performance to each such networked energy saving device, over time and additional energy savings and a potential increase in carbon credits generated by each such networked device, which will be subsequently verifiable by subsequent reporting of each such device over the network to the server and monitoring software running thereon of the system provider.

Still further, it is possible to include location ascertaining software and/or hardware with each networked energy saving device, whereby it can report a geographic location of operation. Such may be by a GPS receiver, or software running on the networked energy saving device which ascertains a location of the IP address of the router through which it connects, or cell tower through which it connects to a network. It is envisioned that each networked device, will include hardware and software adapted to allow the user to wirelessly connect the device through a local WiFi connection to the internet, or software and hardware adapted to connect to a local cellular system to connect to the network, or software and hardware allowing network communication over the power line itself, to which it is engaged to save energy. Such hardware, of course, would be a wired or wireless network interface card or circuit, and software adapted to send information over the network connection of choice once achieved.

By ascertaining locations for individual energy saving devices, which are correlated with their electronic identifier, networked energy saving devices in a geographic area where a power shortage occurs could be signaled to temporarily disconnect the energy consuming component to which they are engaged or signaled to increase the amount of energy being saved by their respective operation if such is not at an operational maximum already. This operation would be particularly valuable in protecting the electrical grid from failure in an emergency or brown out.

Still further, the networked energy saving device herein, can also include a step of relating the individual identifier of each electric saving device communicating over a network with the service provider, with an individual user. In this age of social media, many users of the networked devices, also interrelate with friends and workers using social media sites such as FACEBOOK.

By allowing users to identify themselves and be related to the identifier of one or more networked devices, the system herein can also send out savings reports to the social media pages of such users, as to the amount of energy they have personally saved, and show such an accomplishment to their friends on such social media pages. Such notice to users in this manner will significantly enhance usage by users by encouraging existing users to show their ongoing help with saving carbon emissions to others, and encouraging others to contact the system provider to receive and use their own networked energy saving device so they may to let friends and acquaintances know, they care about carbon emissions and are doing something to help.

Still further, it is envisioned as another step in the system herein, where networked energy saving devices are deployed and related with individual users at determined geographic locations, that the system provider can report energy savings to the local power company of each respective user in a step where such energy savings by a power company user reaps a financial reward from their power provider. Many electric power providers in the United States and other countries, continually attempt to get their customers to conserve electric power usage through providing discounts on energy saving light bulbs, and the like. By doing such, power companies reduce the need to build new power plants, and more widely the need to build “peaker” power plants which come add electricity to the grid during peak demand times.

Using the system herein, the system provider can provide energy savings information, from individual networked energy saving devices which are related to individual customers of respective power companies in a system where the power companies offer a discount or some other reward to the customer relative to the power savings reported from an associated identifier of a networked device owned by that user. Alternatively, such power companies may choose to give away the networked energy saving devices herein to customers and receive aggregate power saved information from the system provider, based on the ongoing reporting of actual energy saved from each respective device associated with a customer.

These steps, encouraging use and distribution of the power saving devices through reporting to social media and power companies for discounts or for wider distribution of the networked energy saving devices by the power companies, will encourage and enlarge the user base over time. In doing so, the system provider is provided with an ongoing increase of the number of energy saving devices being distributed and an ongoing and significant increase in both electric energy saved by such devices which is verifiable in a manner which allows for generation of carbon credit certificates by the authority in the country where such energy is saved which is authorized to generate carbon credits.

In all modes of the system herein, it is preferred that the energy saving device, whether static and autonomous or network engaged to communicate, will provide the user with a visually discernable display which depicts the electric energy saved. Such can be provided by a viewable video display positioned on the energy saving device, showing electric power saved over time, by the engaged device. It is this step of providing visual confirmation to users of actual energy saved, which is also important to encourage ongoing and increased use by current and new users.

The system, as noted, can provide autonomous energy saving devices and network engageable energy saving devices. These can either energy saving devices with and without network communications components and software, or simply one type of energy saving device which will operate autonomously if it does not connect to a network and report to the system provider. In such a case the energy saving devices not connecting to the network will be ascertained to save a calculated amount of electric energy and resulting carbon credits from testing and validation and authority certification.

Where the energy saving devices do subsequently connect to the system provider over a network such as the internet, and communicate the identifier of the device, their respective energy savings and carbon credits may be re calculated instead based on the reported energy savings over time, rather than the fixed amount allocated to devices not reporting. This allows all the energy saving devices to be assigned a fixed energy savings and carbon reduction over time based on testing, validation, and certification, and allows those devices which do connect over the network to the system provider, to have their respective energy savings and resulting carbon credits recalculated to that which is reported over time should it exceed the original amount calculated as an autonomous device.

Such reporting therefore using a network connection, and network communication hardware and software, is most preferred since it allows for an increase in energy savings calculations, as well as the other noted utility of user encouragement, and software and operational updates for increased efficiency.

As used herein the terms network connection, network communication hardware and software, and network are intended to be inclusive of all such hardware, software, and connections as would occur to those skilled in the art, and are used for convenience of description. For example as noted a network can be wireless, wired such as ethernet, wireless cellular, or wired using the actual wires of the electric circuit to which a device engages and power lines connected to routers communicating with the service provider. Hardware can be a wired or wired network interface card and computing components engaged therewith, adapted to discern energy saved by a device, and communicate data correlating to such savings over the network to which an individual device engaged.

Such communications of data would be between each such networked energy saving device and a system provider providing users with such devices where the system provider will have a computer running software in electronic memory adapted to identify and communicate with each respective energy saving device in a one way or two way communication, and to save data concerning the energy saving of each respective energy saving device communicating over the network with the system provider based on an identifier for each respective energy saving device.

A database would be maintained in electronic memory accessible to the computers or servers of the system provider, for storing data on ongoing and/or aggregate electric energy savings related to each energy saving device and its respective identifier and the user of each should such be employed for third party reporting to social media or power companies or other third parties.

With respect to the above description, before explaining at least one preferred embodiment of the herein disclosed energy saving and carbon reducing system for generating carbon credits invention in detail, it is to be understood that the invention is not limited in its application to the details of construction and to the arrangement of the steps in the following description or illustrated in the drawings. The invention herein described is capable of other embodiments and of being practiced and carried out in various ways which will become obvious to those skilled in the art on reading this disclosure. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other electronic and software-enabled systems for generating energy savings and resulting carbon emission reductions and methods and systems for carrying out the several purposes of the present disclosed system. It is important, therefore, that the claims be regarded as including such equivalent construction and methodology insofar as they do not depart from the spirit and scope of the present invention.

Further objectives of this invention will be brought out in the following part of the specification wherein detailed description is for the purpose of fully disclosing the invention without placing limitations thereon.

### BRIEF DESCRIPTION OF DRAWING FIGURES

FIG. 1 depicts an energy saving component of the system herein which may be autonomous or engageable to a network for communication with the system provider and which is given or purchased by users.

FIG. 2 depicts components which may be included in the electric circuits of the energy saving device to reduce electricity use as noted above.

FIG. 3 shows a plurality of individual users of the energy savings device or devices herein, in a mode wherein the energy saving devices are in communication over a network with the system provider and reporting energy savings which is employed to discern saleable carbon credits.

FIG. 4 is a graphic depiction of a mode of the system herein wherein energy saving devices communicate with a system provider savings data, which may in turn be reported to third parties such as social media or power utilities in relation to the user, to encourage widespread use, and increased generation of carbon credits, the sale of which generating proceeds which are employable for purchase and distribution of additional devices, or distributable to the users as a credit against their electric bill.

It should be noted the steps in the system herein described, may be reordered and that other aspects of the present invention shall be more readily understood when considered in conjunction with the accompanying drawings, and the following detailed description, neither of which should be considered limiting.

### DETAILED DESCRIPTION OF THE PREFERRED EMBODIMENTS OF THE INVENTION

In this description, any directional prepositions if employed, such as up, upwardly, down, downwardly, front, back, top, upper, bottom, lower, left, right and other such terms refer to the device or depictions as such may be oriented are describing such as it appears in the drawings and are used for convenience only. Such terms of direction and location are not intended to be limiting or to imply that the device or method herein has to be used or positioned with graphics in any particular orientation. Further computer and network terms such as network, database, browser, data, computer, router, network communications, and other terms, are for descriptive purposes only, and should not be considered limiting, due to the wide variance in the art as to such terms depending on which practitioner is employing them. The system herein should be considered to include any and all manner of software, firmware, operating systems, executable programs, files and file formats, databases, computer languages and the like, as would occur to one skilled in the art in any manner as they would be described, and adapted as required to implement the system herein over a network with multiple users, at multiple locations having one or a plurality of energy saving devices in operation.

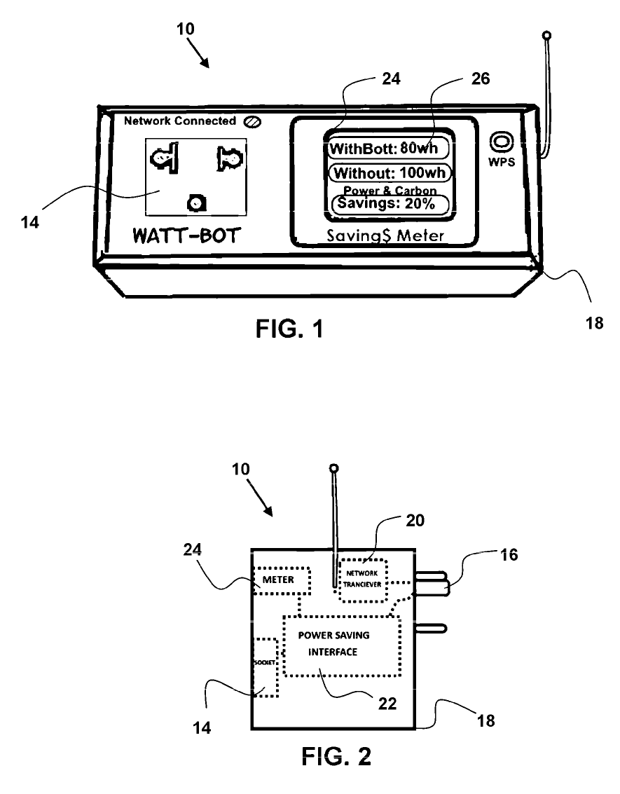

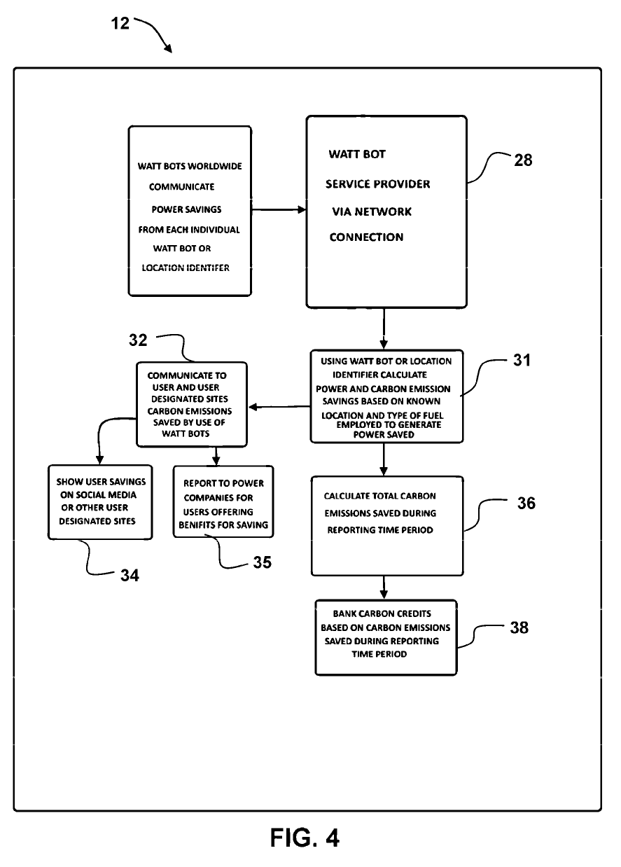

Now referring to drawings in FIG. 1 there is depicted a an energy saving component 10 employable with the system 12 (FIG. 4) herein or similar such systems as would occur to those skilled in the art on reading this disclosure. As shown in FIG. 1, the energy saving component 10 is adapted to interface in between an electric energy using appliance such as a washer, dryer, refrigerator, air conditioner, computer, or other appliance which is adapted to engage an electric receptacle 14, and receive alternating current electricity therefrom for operation. The receptacle 14 shown on the energy saving component 10 may be of any configuration depending on the standard and the country in which the energy saving component 10 is adapted to operate since the complimentary plugs and receptacles 14 vary by country and system.

The energy saving component 10 as shown in FIGS. 1 and 2, thus, is adapted with a connector 16 which is complimentary and engageable to a receptacle 14 of the electric system where the energy saving component 10 is employed, such that the connector 16 engages the electric system of the user, and the connector 16 engaged to an electric energy using appliance, engages with the receptacle 14 on the housing 18 of the energy saving component 10. Thus, the energy saving component 10 is easily interfaced between the eclectic system, and the electric energy using appliance by the employment of the default receptacle 14 and connector 16 adapted to the local system.

As noted the energy saving component 10 may be provided in an autonomous mode and a mode which is adapted for communication with the computing system of a system provider over a network. Also as noted, the energy saving component 10 may simply be configured to communicate over such a network, and be assumed autonomous until or unless the energy saving component 10 connects to the computing system of the service provider, or it may be provided in an autonomous mode with no network communication ability or components, and in a network communicable mode having the software and hardware adapting it to connect to the router or computers of the service provider over a network such as the internet.

As shown in FIG. 2, in a mode of the energy saving component 10 usable for autonomous or network connected operation, a network transceiver 20 can be included such as a wired or wireless network interface card or circuit or the like, which is adapted to communicate over one or a plurality of wired or wireless networks in modes well known in the art. Such will allow the energy saving component 10 employing software adapted to the task of accessing and reporting discerned savings in energy, to report such over a network to the system provider and allow energy savings and resulting carbon emission savings and credits to be calculated using actual saving data, rather than a calculated amount in the autonomous mode of the energy saving component 10.

Also shown in FIG. 2 is the power saving interface of circuitry, microprocessors, software, firmware, and hardware adapted to reduce the power consumption of the electric consuming appliance engaged to the receptacle 14. Noted above are a plurality of U.S. patents concerning such electronic components, circuitry, software, and the like required for the power saving interface 22 of the energy saving component 10, and such are included in this application by their reference above, as well as similar electric energy saving components cited to the noted patents or referenced by them. It is this power saving interface 22 which allows the system 12, herein, to save electricity and resulting carbon emissions, in the method herein to generate carbon credits from such savings, so this power saving interface 22 would be encouraged to change over time to use the most efficient power saving components and circuitry and software. Consequently, the patents cited above as employable as the power saving interface 22, herein, may change over time and should it be ungradable by software or firmware upgrades to the power saving interface 22, such would be preferable to maximize the saving of carbon emissions from the reduction in electric energy used by each electric using appliance connected to a respective energy saving component 10, and thereby maximize the production of new carbon credits from such carbon reduction by the system provider herein.

In operative engagement to the power saving interface 22 is preferably a video display 24 which while optional, is preferred as a viewable means with text or graphics which will inform the user of the actual energy savings provided by use of the energy saving component 10. The video display 24 while shown engaged to the housing 18, might also be a video display of a smartphone, pad computer, or engaged with other computing appliances. Where remotely positioned, the video display 24 would provided alphanumeric characters or graphics visually depicting in a user discernable manner, the energy saved 26 by using the energy saving component 10. Where the video display 24 is remote, such as a smart phone or on a pad computer or laptop, the energy saving component 10 will require the network interface and a connection, and software adapted to communicate data concerning the energy savings to the receiving server or computer which will have software thereon from the system provider, adapted to receive the energy saving data from a energy saving component 10 of the user, and depict the saving 26 on the display 24.

A display 24 in some manner is preferred to encourage users continue use of the energy saving component 10 and to obtain additional energy saving components 10, and thereby increase energy savings, reduce more carbon emissions, and thereby generate more carbon credits for the system provider.

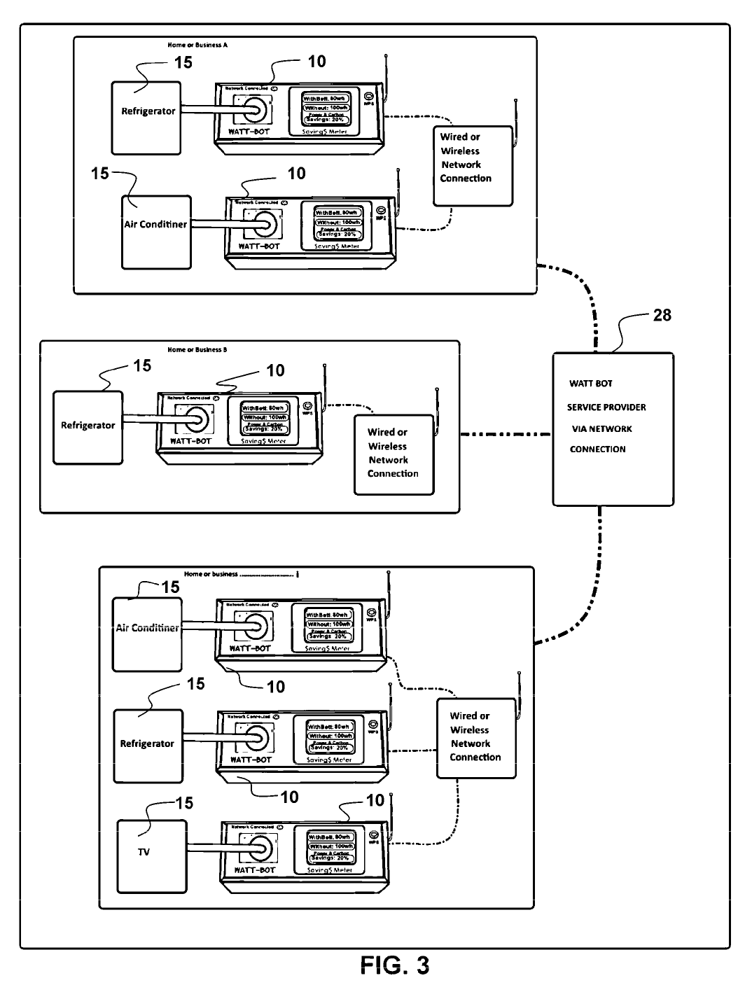

As shown in FIG. 3, the system 12 herein can accommodate multiple users with one or a plurality of individual energy saving components 10. Each energy saving component 10 may be connected to an individual electric appliance or component 15 which uses electricity, and thereby reduce the electric energy used by the respective appliance or component 15 respectively connected.

Noted above, the energy saving components 10 may be autonomous, and the energy saved thereby, and carbon reduced, calculated based on testing, validation, and carbon credits issued based on the energy saving by the certifying authority. Also as noted, the energy saving components 10 which are autonomous may be configured as such without a network interface or transceiver 20, or may include such but be considered autonomous and fixed in energy savings until a network communication with the energy saving component 10 is established, and the energy saving component 10 identified with an electronic or other identifier.

In the system 12, it is preferable that the energy saving component 10 is configured for and achieves a connection of the energy saving component 10 over a wired or wireless network connection or combinations thereof with the server 28 (FIG. 4) of the system provider. As noted, the use of the term server 28 means a network engaged computer or router of the system provider, which has software running in electronic memory adapted to discern an electronic communication from a energy saving component 10 over the network, and to receive electronic data from an identified energy saving component 10 correlating to actual energy saved by the energy saving component 10 at its location. Further, the server 28 of the system provider may also be configured with software adapted to communicate software or firmware updates held in electronic memory accessible by the server 28, to the controller, sever, or computing device 30 within a power saving interface 22 or connected thereto, to increase efficiency.

With the energy saving components 10, in network communication with the server 28 of the system provider, a significant increase in verifiable energy savings and carbon emission reduction is possible versus the calculated savings of an autonomous energy saving component 10, and thus such network communication is preferable to maximize verifiable energy savings and resulting verified carbon emission reduction and carbon credits attributable to the system provider. These additional savings can also be seen in FIG. 3 where the energy saving components 10 are engaged to differing electric using components 15 which would have respectively differing energy savings attributable for calculation of carbon credits. While the autonomous energy saving component 10 will use a calculated energy savings from testing, verification, and certification noted above, this must be averaged because it is unknown what electric using component 15 is connected to a energy saving component 10.

With the energy saving component 10 in a network connection with the router 28 of the system provider, the calculation energy savings 31 from those electricity-using components 15 having a significantly higher power draw from that assumed with the autonomous mode of the energy saving component 10, will also be higher, and can be captured by the system provider, to calculate carbon emission reduction 36, and thus result in a higher level of carbon credits attributable to the system provider which may be banked 38 or sold.

Therefor the system 12 using networked energy saving components 10 is preferable and users of the energy saving components 10 should be encouraged to connect them to a network, or the energy saving components 10 themselves should by default connect to a network such as a local cellular network, or a network using the power lines to which they are engaged, by default. In this networked engagement, each energy saving component 10 would have a device identifier that is electronically communicable over the network to the router 28 of the system provider.

In this fashion, each networked energy saving component 10 is identifiable individually for purposes of relating energy savings to each energy saving component 10, or associating a user with a energy saving component 10, and associating ongoing and total aggregate energy savings to identified energy saving components 10 on a network, such that for each networked energy saving component 10, a calculation of carbon emission savings 36 can be stored in a database in electronic memory an employed on an ongoing basis to calculate carbon credits 38 for the system provider, based on the ongoing performance of the identified energy saving component 10 rather than a fixed calculation of an autonomous non connected energy saving component 10. As noted earlier, each energy saving component 10 and identifier can be related to an owner for additional steps in the system 12. This identifier might for example be a MAC ID of the network interface of the network transceiver 20.

As noted, another step in the system 12 herein, can include a GPS receiver, or network IP address based means to calculate a geographic location 31 of each energy savings energy saving component 10. This step in many instances can also result in an increase in the calculation of carbon emission saved 36 by a energy saving component 10, based on the type of electric energy generation used by the power company in that geographic location. For example, a power company in a determined geographic location using coal to generate electricity, would emit significantly more carbon into the atmosphere than a power generator using oil or natural gas. Thus, including a component and/or software on the energy saving component 10 adapted to discern a geographic location of operation, would be a preferable option to maximize the accuracy of the calculation of carbon emissions saved 36 for the system provider for each such energy saving component 10.

Where a cellular network is employed, the energy saving component 10 would have the network transceiver 20 adapted to connect to the cellular network and communicate data concerning power savings to the router 28 of the system provider. Using a power line network, the network transceiver will be adapted to communicate electronically over the power lines connected to the socket to which the connector 16 engages, and communicate power saving data information to the router of the system provider. In such a case, users may be offered an option to use another network.

As also noted above, in another optional but preferred step of the system 12, data concerning energy savings and carbon emission reduction, can be relayed by the system provider 32 to third parties such as social media sites 34 or to the power company servicing the local user 35. As noted above, the power company may employ such for providing the user with reduced rates or other rewards or incentives for reducing the power requirements of the grid, and display of carbon emission reduction on social media of the user, would encourage further use by that user and others, and might develop contests between users on social media as to who can save more energy.

This step to encourage more and widespread use, much like the preference for energy saving components 10 engaged over a network, is preferable since for the system provider, more users and use of the energy saving components 10 will result in additional energy savings and carbon emission reduction, which will result in a higher calculation for carbon emissions saved 36 based on the criteria for such by certifying authorities, and an increase in carbon credits the system provider may bank 38 or employ against carbon emissions by the system provider, or which the system provider can sell to help defray the cost of the system.

While all of the fundamental characteristics and features of the energy saving system for reducing carbon emissions and generating carbon credits herein have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that upon reading this disclosure and becoming aware of the disclosed novel and useful system, various substitutions, modifications, and variations may occur to and be made by those skilled in the art without departing from the spirit or scope of the invention. Consequently, all such modifications and variations and substitutions, as would occur to those skilled in the art are considered included within the scope of the invention as defined by the following claims.

What is claimed is:

1. A method for saving electric energy and generating saleable carbon credits comprising:
manufacturing a plurality of electric energy saving components adapted for an operative positioning in-between an electricity supply and an appliance using electric energy from said electricity supply;
ascertaining an aggregate amount of electric energy saved by the operative positioning said energy saving component in-between said electricity supply and a said appliance;
calculating an aggregate reduction of carbon emissions into the atmosphere from said aggregate amount of electric energy saved;
conducting a sale of carbon credits generated by said aggregate reduction of carbon emissions;
employing proceeds from said sale of carbon credits to fund costs of subsequently manufactured said energy saving components; and
distributing said subsequently manufactures energy savings components for free or at discounted prices to subsequent users, whereby energy savings and carbon reduction are significantly increased by the discounted and free distribution of said energy saving components to users who cannot afford them.

2. The method for saving electric energy and generating saleable carbon credits of claim 1, additionally comprising:
including an identifier in said energy saving components;
employing a network communicator in said energy saving components, to communicate said aggregate amount of electric energy saved by said energy saving component to a server over a network;
matching said identifier to an identified user of said energy saving component; and
communicating a graphically displayed message to a social media page of said identified user depicting said aggregate amount of electric energy saved by said identified user.

3. The method for saving electric energy and generating saleable carbon credits of claim 1, additionally comprising:
including an identifier in said energy saving components;
employing a network communicator in said energy saving components, to communicate said aggregate amount of electric energy saved by said energy saving component to a server over a network;
matching said identifier to an identified user of said energy saving component; and
employing a portion of said proceeds from said sale of carbon credits in a payment to the electricity provider of said identified user.

4. The method for saving electric energy and generating saleable carbon credits of claim 1, additionally comprising:
including an identifier in said energy saving components;
employing a network communicator in said energy saving components, to communicate said aggregate amount of electric energy saved by said energy saving component to a server over a network;
matching said identifier to an identified user of said energy saving component;
employing a portion of said proceeds from said sale of carbon credits in a payment to the electricity provider of said identified user; and
communicating a graphically displayed message to a social media page of said identified user depicting said aggregate amount of electric energy saved by said identified user.

5. The method for saving electric energy and generating saleable carbon credits of claim 1, additionally comprising:
including an identifier in said energy saving components;
employing a network communicator in said energy saving components, to communicate said aggregate amount of electric energy saved by said energy saving component to a server over a network;
matching said identifier to a terrestrial location of said electric energy component;
determining the fossil fuel employed at said terrestrial location to generate said electric energy saved;
calculating said aggregate reduction of carbon emissions into the atmosphere from said aggregate amount of electric energy saved based on said fossil fuel determined as employed at said terrestrial location.

6. The method for saving electric energy and generating saleable carbon credits of claim 1, additionally comprising:
including an identifier in said energy saving components;
employing a network communicator in said energy saving components, to communicate said aggregate amount of electric energy saved by said energy saving component to a server over a network;
matching said identifier to a terrestrial location of said electric energy component; and
during power shortages in said terrestrial location, messaging said network communicator on said energy savings components located in said terrestrial location, to reduce an amount of said electric energy from said electricity supply communicated to said appliance.
